(19) United States
(12) Patent Application Publication
(10) Pub. No.: US 2011/0035277 A1
(43) Pub. Date: Feb. 10, 2011

(54) SYSTEM FOR SCHEDULING ADVERTISEMENTS AND METHOD THEREOF

(76) Inventors: Muralidharan Kodialam, Marlboro, NJ (US); Tirunell Lakshman, Morganville, NJ (US); Sarit Mukherjee, Marlboro, NJ (US); Limin Wang, Plainsboro, NJ (US)

Correspondence Address: HARNESS, DICKEY & PIERCE, P.L.C., P.O. BOX 8910, RESTON, VA, 20195, US

(21) Appl. No.: 12/536,159

(22) Filed: Aug. 5, 2009

(51) Int. Cl. G06Q 30/00

(52) U.S. Cl. 705/14.46

(57) ABSTRACT

The system for scheduling advertisements includes at least one ad bidder and an ad scheduler. The ad bidder is configured to receive bidding information for a plurality of ads from one or more advertisers. The bidding information for each ad includes at least one target profile information and a bid associated with the target profile information. The bid indicates expected revenue for showing the ad to a viewer having actual profile information corresponding to the target profile information associated with the bid. The ad scheduler is configured to schedule which of the plurality of ads is received by which of a plurality of viewers based on the actual profile information of the plurality of viewers and the bidding information such that an ad scheduled for one of the plurality of viewers is influenced by a correspondence of the scheduled ad to others of the plurality of viewers.

### BACKGROUND

1. Field

One or more example embodiments relate to targeted advertising, for example, to a method or system for targeting advertisements (“ads”) to television (“TV”) viewers using multiple services from a single provider.

2. Description of the Related Art

Over-the-top application service providers (e.g., web-based or online service providers) are generating larger revenues through effective targeting of content (e.g., ads) to users using their services. Selection of the best ad to display to the user is a well-known problem in web-based advertising. Service providers currently use relatively sophisticated algorithms to select the ad that best matches the user's current interests while simultaneously maximizing the service provider's web-based revenue from the ads. The user's current interest may be determined from search keywords and/or recent website visits. Such algorithms usually let an advertiser bid on the keywords that the advertiser determines useful for marketing its product.

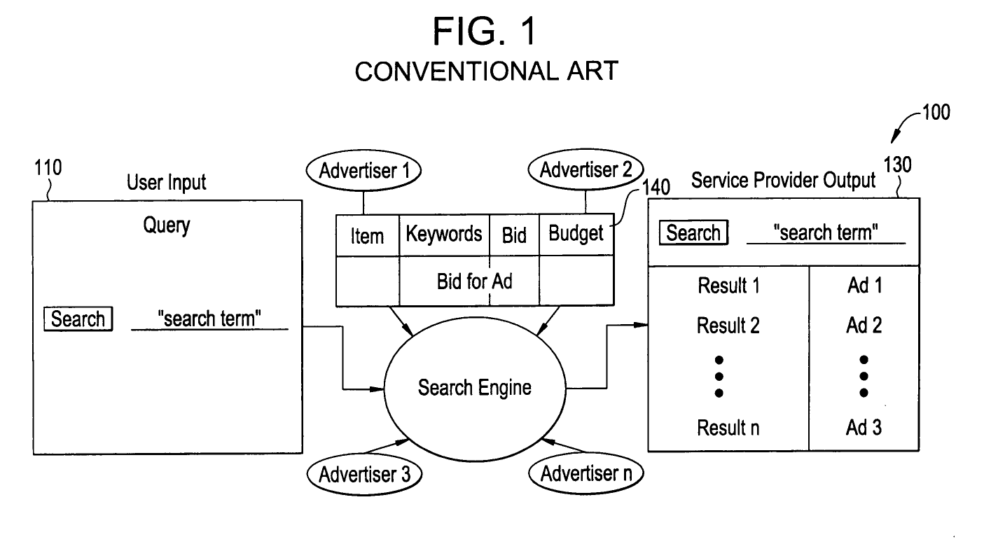

FIG. 1 illustrates a conventional bidding model 100 for online service providers. In FIG. 1, an online service provider that provides Internet search services is shown. In a web browser, a user enters a search term at a query web page 110 of the service provider. The service provider then processes the search term 120 and provides results of the query at a results web page 130. However, the results web page also includes ads alongside the search results based on the search terms of the user. More specifically, advertisers 1-n bid to have their ads placed in the results web page 130 using a bidding entry 140. For example, a common bidding entry 140 includes fields for item, keywords, bid and budget. The item field indicates the advertisement (e.g. a clip, text, or image) that the advertiser wishes to display. The keyword field indicates in relation to which search terms the ad of the item field should be shown. The bid field indicates the amount of money the advertiser is willing to pay for each display and/or click of its ad on the results web page 130. A higher bid value may result in a strong likelihood of the ad being shown and therefore a greater cost to the advertiser. The budget field indicates the total amount of money the advertiser is willing to spend to have the ad shown. For instance, the online service provider will deduct the bid value from the budget each time the ad is displayed and/or clicked on by a user in the results web page 130.

While such solutions may be suitable for web-based advertising, these solutions are not suitable for television-based advertising. This is because there are substantial differences in the way ads can be placed between online services (e.g. web-based services) and TV services (e.g. broadcast or cable services).

### SUMMARY

According to an example embodiment, a system for scheduling advertisements includes at least one ad bidder and an ad scheduler. The at least one ad bidder is configured to receive bidding information for a plurality of ads from one or more advertisers. The bidding information for each ad includes at least one target profile information and a bid associated with the target profile information. The bid indicates expected revenue for showing the ad to a viewer having actual profile information corresponding to the target profile information associated with the bid. The ad scheduler is configured to schedule which of the plurality of ads is received by which of a plurality of viewers based on the actual profile information of the plurality of viewers and the bidding information such that an ad scheduled for one of the plurality of viewers is influenced by a correspondence of the scheduled ad to others of the plurality of viewers.

### BRIEF DESCRIPTION

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates a conventional bidding model for online services;

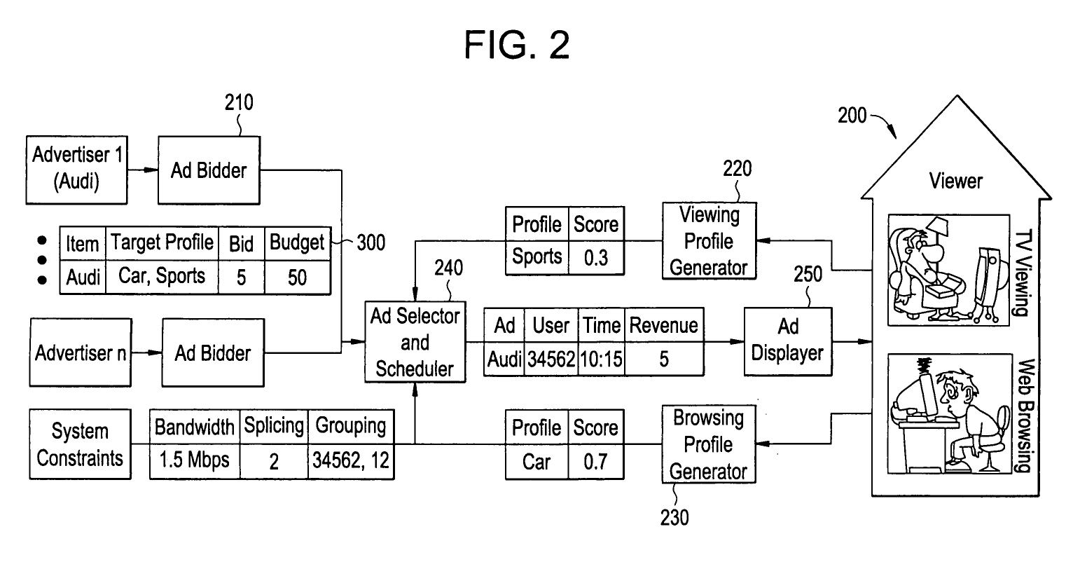

FIG. 2 illustrates a system for targeting an advertisement according to an example embodiment;

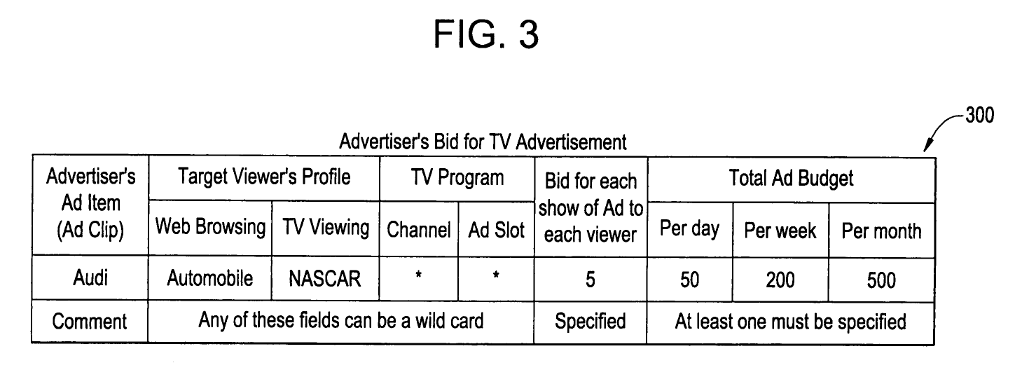

FIG. 3 illustrates a bidding entry for TV services according to an example embodiment;

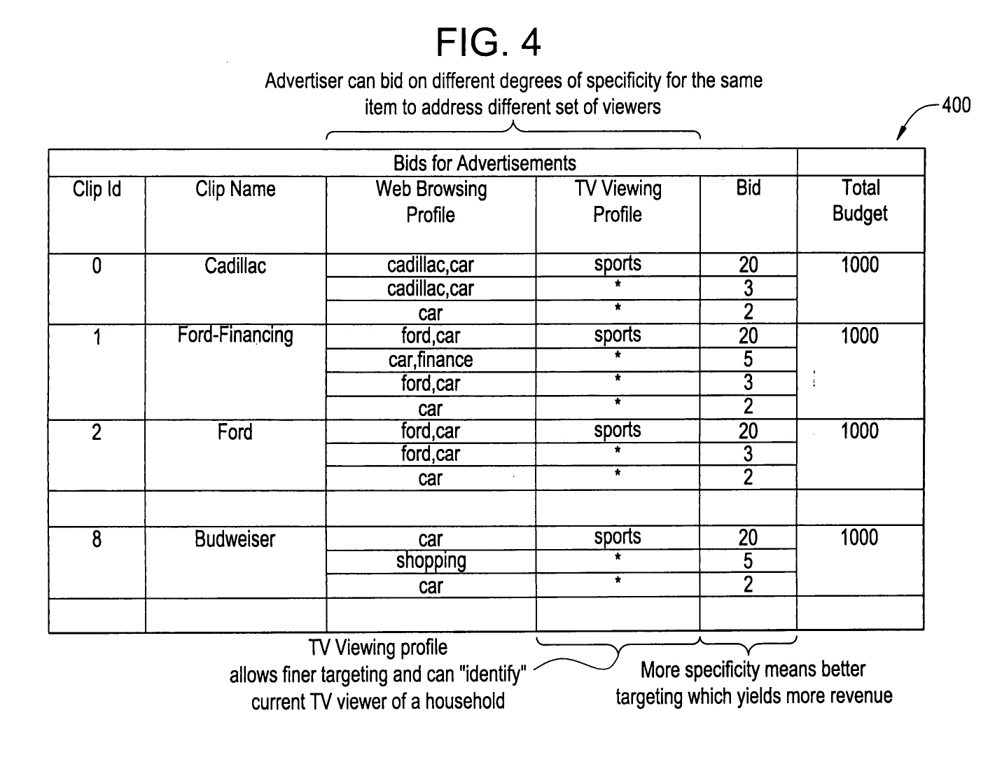

FIG. 4 illustrates an example of the target viewer profile in FIG. 2;

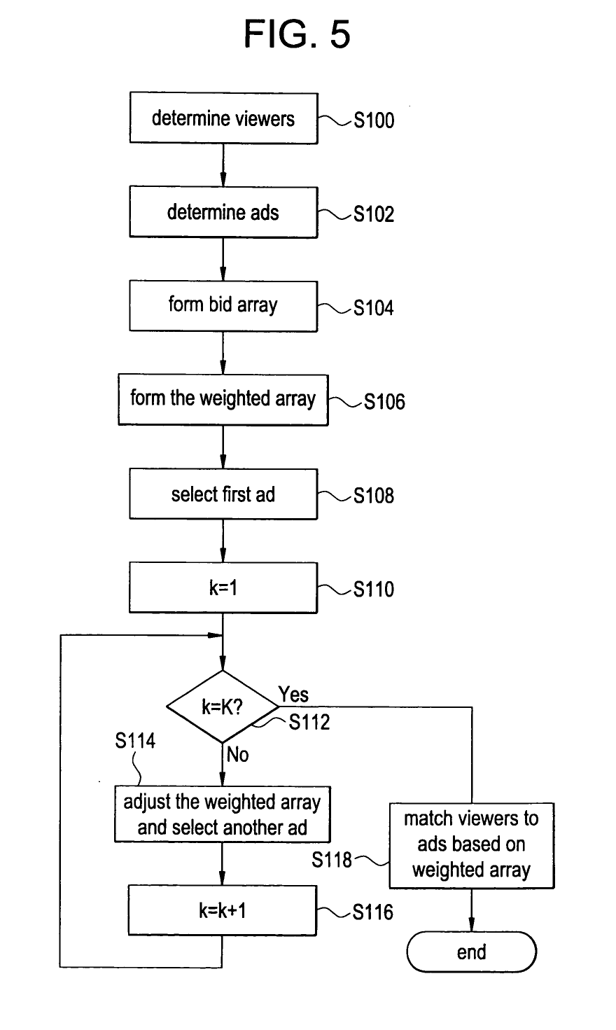

FIG. 5 illustrates a method for targeting an advertisement according to an example embodiment;

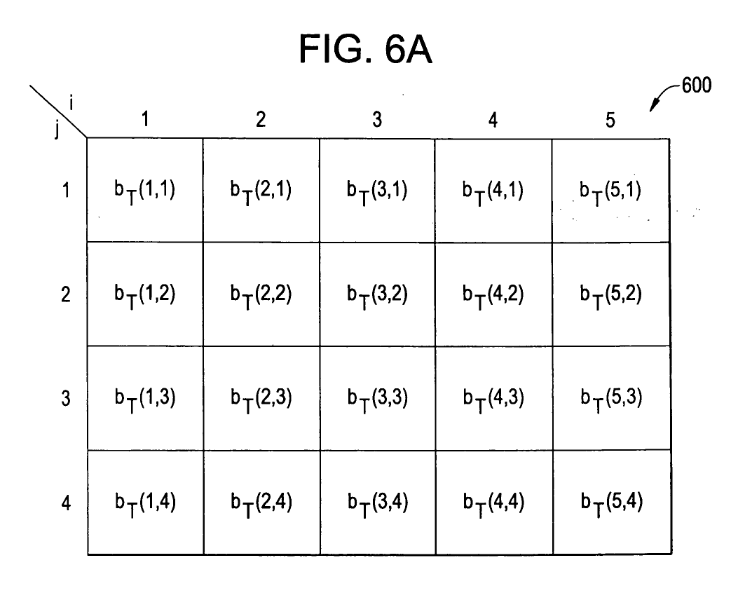

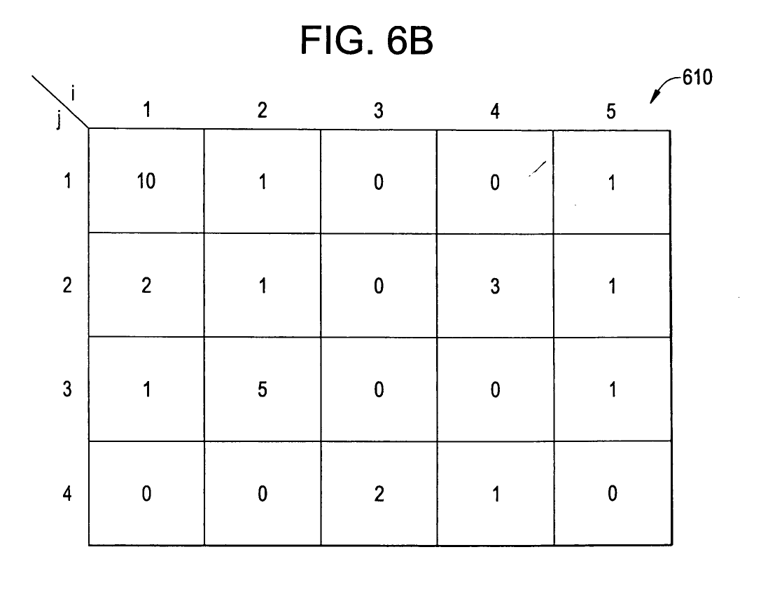

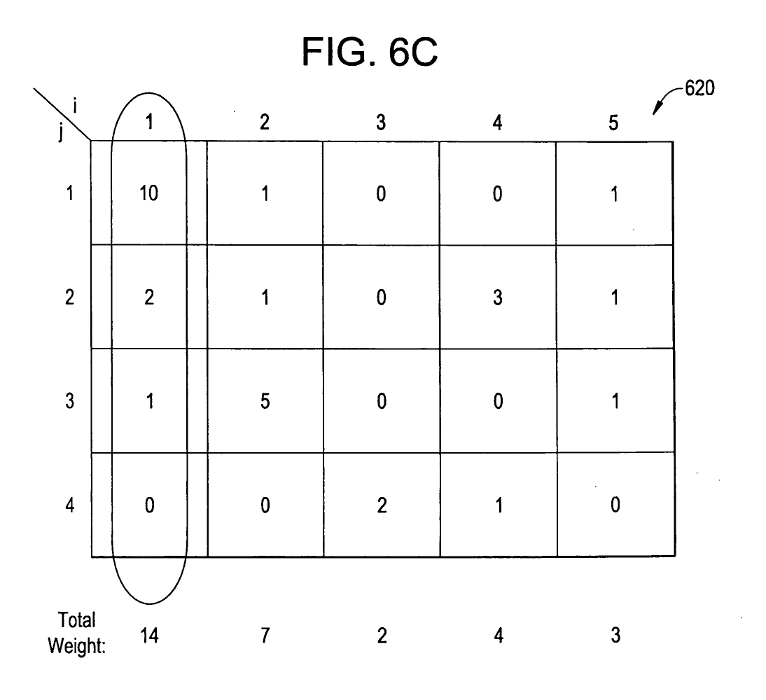

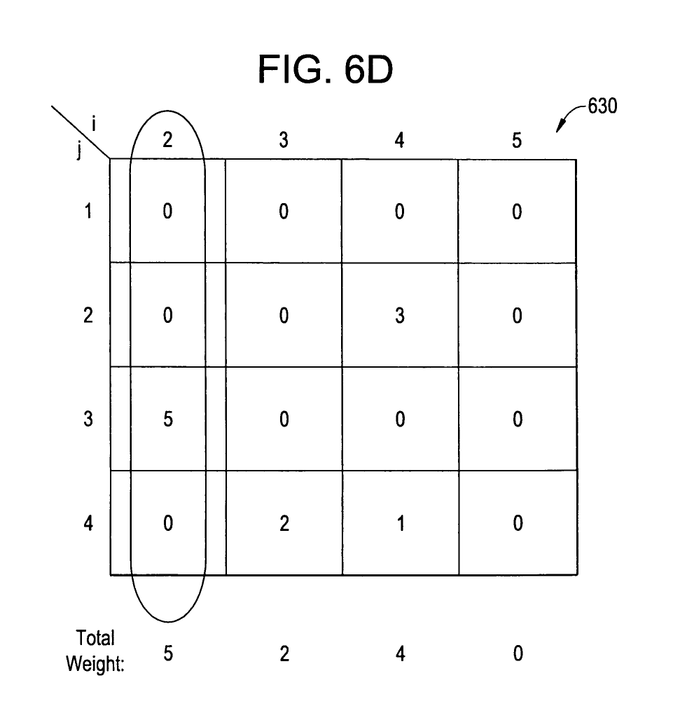

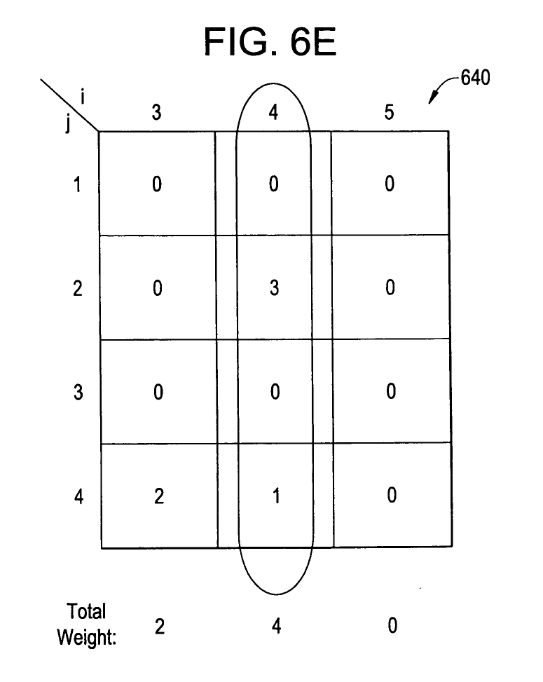

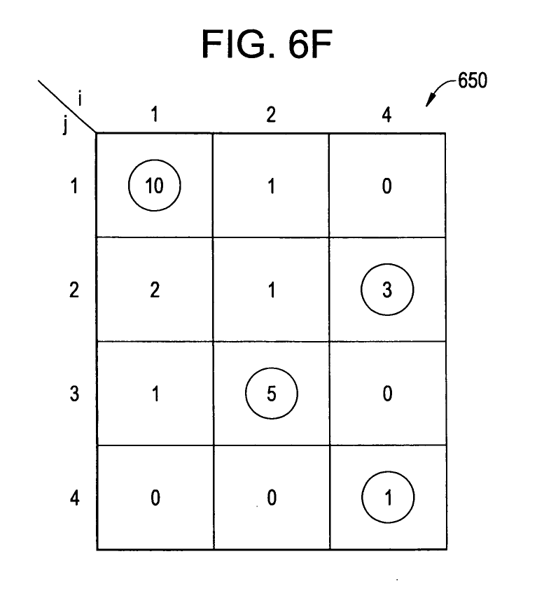

FIG. 6A illustrates a bid array according to an example embodiment;

FIG. 6B illustrates an example of a weighted array according to example embodiment;

FIG. 6C illustrates an example of selecting a first ad from the weighted array of FIG. 6B;

FIG. 6D illustrates an example of adjusting the weighted array of FIG. 6C and selecting a second ad from the adjusted weighted array of FIG. 6C;

FIG. 6E illustrates an example of adjusting the weighted array of FIG. 6D and selecting a third ad from the adjusted weighted array of FIG. 6D; and

FIG. 6F illustrates an example of scheduling the selected ads to the plurality of viewers according to an example embodiment.

### DETAILED DESCRIPTION

Various example embodiments will now be described more fully with reference to the accompanying drawings.

Specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent”, etc.).

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Specific details are given in the following description to provide a thorough understanding of example embodiments. However, it will be understood by one of ordinary skill in the art that example embodiments may be practiced without these specific details. For example, systems may be shown in block diagrams in order not to obscure example embodiments in unnecessary detail. In other instances, well-known processes, structures and techniques may be shown without unnecessary detail in order to avoid obscuring example embodiments.

Also, it is noted that example embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process may be terminated when its operations are completed, but could have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Where a service provider provides multiple service domains (e.g. internet, television and/or phone) to a user or viewer, the service provider is able to inspect a multitude of various user generated traffic and parameters, such as web-browsing activities of the users, TV channel surfing information, video-on-demand orders by the viewers, mobile traffic generated by the users, location information of mobile users, etc. The terms users and viewer may be used interchangeably.

Access to different service domains of the user by a single service provider provides opportunities for more enhanced advertisement selection. For example, the service provider only providing online services to the user via the Internet can place targeted content and ads only on web pages carrying the user's personalized results. However, the service provider providing services to the user via multiple service domains has unique information for personalizing services by collecting information available only in its network from across the multiple service domains. Thus, the service providers can blend the information gathered from the multiple service domains to enhance targeted advertising to the user for one or more of the user's service domains.

For example, the service provider may provide at least two service domains to the user, such as TV and online services. From the TV viewing patterns of the viewer, the service provider will be able to extract viewer viewing preferences. For instance, ads for sports cars can be sent to the viewer who watches auto racing events. From the online web traffic of the user, the service provider will be able to similarly extract user interests. Thus, an actual viewer profile created by the service provider from viewer interests will be more comprehensive because it will include profile information from the TV viewing patterns as well as the web traffic of the user. The ads can be added during web access as well as within TV programs. The ads in the TV service can be, for example, 30-seconds commercials as well as rolling text.

However, there are differences between a viewer display for online and TV services. For the online services, the advertisers compete on virtually unlimited screen space of a web page while for the TV services, the advertisers compete for limited screen time.

Regarding screen time, for the online services, targeted ads are displayed as and when the user completes a search. Whereas in the TV services, ads can be inserted only during defined ad time slots. Thus, different ads will contend for the limited number of time-slots for the TV services.

Regarding the timeliness of ads, for the online services, advertisers place online ads on websites when a user inquires about a related item. For the online services, the closer the ad is shown to the keyword search time, the more advantageous this is for the advertiser. With digital TV, ads may be targeted to the viewer or to a group of viewers in real-time since in digital TV it is possible to determine if a particular TV set is tuned to a particular channel in real-time.

Regarding the actual viewer profiles, for the online services, the service provider can use the user's past searches to better target an ad. For the TV services, the service provider has access to the viewer's viewing habits (e.g. by analyzing Internet Group Management Protocol (“IGMP”) logs for Internet Protocol Television (“IPTV”)) in addition to the web browsing profile, which can be used for more appropriate ad selection.

Another factor to consider is resource usage. For the TV service, the service provider should consider the viewer's current channel information and network resource availability for creating targeted ads to groups (instead of individual viewers) since dynamic ad insertion in a TV environment requires additional processing and networking resources. For example, if real-time ad splicing is used to insert ads into a broadcast stream, then the number of ads that can be shown during one time-slot is limited by the number of streams the splicer can splice in real-time. If channel switching is used to show a targeted ad, then the number of independent ads is limited by the number of available ad channels at the beginning of a time-slot.

For websites, bidding on ads by advertisers can be based on keywords and their rank order (popularity), whereas for IPTV service, bidding can be based on keywords, time-slot(s) to place the ad, timeliness of ad placement, number of shows to a viewer, chance of viewing the ad, etc.

In example embodiments, it is assumed that the service provider has knowledge of the actual viewer profile, which is based on multiple sources, and that the advertisers bid on the profiles to show an ad to a viewer. Therefore, an example embodiment may select and schedule ads to the viewers so that the highest or higher matched ad is shown to the viewer while maximizing or increasing the service provider's revenue.

FIG. 2 illustrates a system 200 for targeting an advertisement according to an example embodiment. In FIG. 2, the system includes one or more ad bidders 210, a viewing profile generator 220, a browsing profile generator 230, an ad selector and scheduler 240, and an ad displayer 250. The system 200 shows a separate ad bidder 210 for each of the advertisers 1-n. However, a single or less than n (where n is a natural number) ad bidders 210 may also be used for a plurality of the advertisers 1-n. The ad bidder 210 is configured to receive bidding information for a plurality of ads from one or more advertisers, the bidding information for each ad including at least one target profile information and a bid associated with the target profile information, the bid indicating expected revenue for showing the ad to a viewer having actual profile information corresponding to the target profile information associated with the bid. The ad bidder 210 may receive the bidding information through, for example, a bidding entry from the advertiser 1-n. Alternatively, the ad bidder 210 may receive bidding information from the advertisers in various other formats than a bidding entry.

The ad bidder 210 may include hardware and/or software capable of receiving, collecting, processing, and forwarding the bidding entry of the advertisers 1-n. For example, the ad bidder 210 may include a processor (not shown) to receive, process and forward the bidding entry and a memory (not shown) that may store the bidding entry and/or programs for use with the processor. The advertisers 1-n may send the bidding entry to the ad bidder 210 via a network (not shown). The network may include, for example, one or more networks (such as a cable or Internet network), control circuits, servers (such as application web servers or database servers), routers or gateways, hubs or switches, and various other network elements.

The advertiser's bidding entry 300 received by the ad bidder 210 is explained in more detail with respect to FIGS. 3 and 4. FIG. 3 illustrates the bidding entry 300 for TV services according to an example embodiment. The bidding entry 300 allows an advertiser to bid based on a target viewer profile. The bidding entry 300 includes fields for the advertiser's ad item, the target viewer profile, the TV program, the bid for each showing of the ad to each viewer, and the total ad budget.

The advertiser's ad item field indicates the ads (e.g. a clip, text, or image) that the advertiser wishes to display. The target viewer profile field allows the advertiser to indicate the type of viewers to which the advertiser seeks to correlate its ad. In particular, the target viewer profile field includes target profile information sub-fields for web-browsing and TV viewing. The web-browsing target profile information sub-field allows the advertiser to indicate a target web-browsing profile according to a category or sub-category and the TV viewing target profile information sub-field allows the advertiser to indicate a target TV viewing profile according to a category or sub-category. For example, in FIG. 3, the advertiser indicates the category “Automobile” for the target web-browsing profile and the category “NASCAR” for the target TV viewer profile. The categories and sub-categories may be identified by one or more keywords that are commonly used by both the advertiser and the service provider. For example, the advertiser may select the keywords from a drop-down menu, a searchable database, an index, etc., provided by the service provider. For instance, in another embodiment, the ad bidder 210 may be hosted by the service provider and the advertisers 1-n may access the ad bidder 210 through the network (not shown).

The TV program field includes the sub-fields channel and ad slot. The TV program field allows an advertiser to bid for a particular ad slot during a particular TV program that can be identified through the channel and the ad slot fields (for simplicity of description, its is assumed that all ad slots for a TV channel are numbered). Thus, unlike internet ads, the TV program field allow advertisers to bid on the TV program in which the advertiser wants the ad to be shown.

All of the fields for the target viewer profile and TV program are optional. For example, the advertiser may only fill out the TV program field and leave the target viewer profile field blank. While the target viewer profile field lets the advertise target an individual or a group of viewers, the TV program field, which is an ad slot-based bid, focuses on demography based targeting as used in the current market place.

The field including the bid for each showing of the ad to each viewer indicates the amount of money the advertiser is willing to pay for each showing of the ad to each viewer. Alternatively, the bid may also apply to a group of viewers. The total ad budget field indicates the maximum amount of money that the advertiser is willing to pay in a given period. In the total ad budget field, sub-fields per day, per week and per month are included. The per day sub-field indicates the amount of money the advertiser is willing to spend per day. Similarly, the per week and per month sub-fields indicate the amount of money the advertiser is willing to spend per week and per month, respectively. The total ad budget field may also include additional fields for different periods of time such as per year, per weekday, per weekend, etc. Thus, the advertiser's bid is deducted from one or more sub-fields of the total ad budget field each time the advertiser's ad is shown to the viewer by the ad selector and scheduler 240, as explained in further detail below with respect to FIG. 2.

Returning to FIG. 2, at least part of the advertiser's 1 bidding entry 300 is shown to include the ad item “Audi” for the web browsing target profile “car” and the TV viewing target profile “sports.” Further, the advertiser 1 may bid a value of 5 and have a total budget of 50 for one day.

It is assumed that the service provider maintains an actual viewer profile that includes a database on the viewer's interests. This database can be a static one created by the service provider from external databases (e.g., zip code, credit history, etc), provided by the viewer (e.g., viewer explicitly sets preferences on ads), or created dynamically by monitoring the viewer's current activities (e.g., web browsing, TV viewing, mobile usage, etc). For example, in FIG. 2, the database is created by monitoring the viewer's activities and may be stored, for example, in any one of the viewing profile generator 220, the browsing profile generator 230, and the ad selector and scheduler 240.

The collected viewer's activities are used to rate the viewer's interests in the various categories and/or sub-categories, which are commonly used by the advertiser and the service provider, of the actual viewer profile of the viewer. The categories may be defined by keywords such as automobiles, travel, investing, cooking, etc. The sub- categories may be further defined by keyword such as auto sales, antique autos, auto maintenance, etc.

The viewing profile generator 220 and the browsing profile generator 230 may include hardware and/or software capable of receiving, collecting and processing individual viewing habit information from the viewer. For example, the viewing profile generator 220 and the browsing profile generator 230 may each include a processor (not shown) and a memory (not shown) that may store data and/or programs for use with the processor.

The viewing profile generator 220 is configured to generate the viewer's actual TV viewing profile based on mining the viewer's TV viewing habits and the browsing profile generator 230 is configured to generate the viewer's actual web browsing profile based on mining the viewer's web browsing habits. The actual TV viewing profile and the actual web browsing profile may form a single actual viewer profile or multiple actual viewer profiles. The viewing profile generator 220 is configured to mine the viewer's TV viewing habits based on information about at least one of a channel watched by the viewer and a time period the channel is watched by the viewer. The browsing profile generator 230 is configured to mine the viewer's web browsing habits based on information about at least one of the web pages visited and intern et searches by the viewer.

Devices of the viewer may include any type of device which allows the service provider to send and receive information regarding TV and online services to and from viewer, such as a TV, set top box (STB), computer, modem, etc, through the network (not shown).

For simplicity of description, the system 200 in FIG. 2 illustrates a single household viewer having two devices. However, the system 200 may include any number of devices and viewers. Accordingly, the term viewer may also collectively refer to the viewers and the viewer devices or an individual viewer device. Furthermore, there may be any number of intermediate devices between the advertisers 1-n and the viewers.

Based on the viewer's activity, the viewing profile generator 220 and the browsing profile generator 230 may each generate a score between 0 and 1 for the various categories and/or sub-categories of the actual viewer profile. The score indicates a strength of the correlation between the viewer's activities and the associated category and/or sub-category. For example, a score of “1” may indicate a strong correlation while a score of “0” may indicate a weak correlation. The correlation may be determined according to any algorithm known in the art. For example, the correlation may be determined based on a percentage of the viewer's total activities that fall under the associated category and/or sub-category during a defined period of time. The categories of each of the actual viewer profiles may be arranged in descending order of score.

In FIG. 2, the advertiser selects the category “Sports” for the target TV viewing profile and the category “Car” for the target web browsing profile of the target viewer profile. According to the viewer's TV viewing activities, the viewing profile generator 220 generates a score of 0.3 for the category “sports” of the actual viewer profile. Further, according to the viewer's web browsing activities, the browsing profile generator 230 generates a score of 0.7 for the category “car” of the actual viewer profile.

The ad selector and scheduler 240 will then select the viewers that have a score above a certain threshold for the categories in their actual viewer profile that match the categories of the target viewer profile indicated by the advertiser. The ad selector and scheduler 240 is configured to schedule which ads are received by which viewers based on actual television and web-browsing habits of the viewers and the bidding information. For example, in FIG. 2, the ad selector and scheduler 240 is more likely to select the ad for the viewer if the advertiser lists the category “car” than if the advertiser lists the category “sports,” depending on the threshold.

FIG. 4 illustrates another example of target viewer profiles in FIG. 3. The clip ID and clip name field correspond to the advertiser's ad item field in FIG. 3 and represent video clips. The bid field corresponds to the bid for each showing of the ad to a viewer having an actual target profile that most closely corresponds to the target viewer profile. The total budget field corresponds to one or more of the sub-fields of the total ad budget field in FIG. 3. As shown in FIG. 4, each ad in the clip name field may be correlated with multiple target viewer profiles of the target viewer profile field, each of the target viewer profiles including fields for web browsing and TV viewing, where the web-browsing field and the TV viewing field allow the advertiser to indicate one or more categories or sub-categories using keywords. Further, the advertiser may indicate a separate bid value through the bid field for each of the target viewer profiles. Thus, an advertiser can simultaneously bid different values on multiple target viewer profiles. However, the advertisers do not directly bid on individual viewers. Instead, the advertiser indicates the amount of money the advertiser is willing to pay in the bid field to target a viewer in this time slot that most closely matches the target viewer profile. The matching of the target viewer profile to a viewer is carried out through the actual viewer profile as explained above with respect to FIGS. 2 and 3 of the viewer. Therefore, each of the ads is correlated to one or more of the target viewer profiles and each of the target viewer profiles is correlated with one of the bid values. Thus, the bidding information or the bid entry may include separate bids for different types of at least one of the target television and web-browsing habits.

This allows the advertiser to tailor the same ad with different degrees of specificity according to different sets of desired viewers. As a result, the advertiser can more finely target the showing of its ads to yield higher revenue in relation to the money spent on advertising.

For example, in FIG. 4, the ad having a clip “Cadillac” is associated by the advertiser with three different target viewer profiles. For a first target viewer profile, the advertiser is willing to bid a value of 20 if the viewer's web browsing profile matches both of the keywords “cadillac” and “car” and the same viewer's TV viewing profile matches the keyword “sports.” For a second target viewer profile, the advertiser is willing to bid a value of 3 if the viewer's web browsing profile matches both of the keywords “cadillac” and “car” and the same viewer's TV viewing profile does not match the keyword “sports” (where the wildcard symbol “*” indicates any keyword other than “sports”). For a third target viewer profile, the advertiser is willing to bid a value of 2 if the viewer's web browsing profile matches the keyword “car” and the same viewer's TV viewing profile does not match the keyword “sports.” The total budget for all three of the viewer fields remains 1000.

Thus, in this case, the advertiser is willing to pay a much higher value (e.g. a bid of 20), which generates a higher revenue for the service provider, if the Cadillac ad is displayed to a viewer or group of viewers who show an interest in Cadillac sports cars through their TV and web browsing activities. On the other hand, the advertiser will pay a much a lower value (e.g. a bid of 2) to display the Cadillac ad to a viewer or group of viewers who only indicate an interest in cars through their TV and web browsing activities.

As explained above, the advertisers are allowed to bid on different types of target viewer profiles and/or TV ad slots of their interests through the ad bidders 210. The advertisers are also asked to allocate a budget for their bid that is valid for a period of time during which they are interested in showing their ad. The advertisers may specify the bid value once for a given time period or to change the bid value dynamically from time to time. Just before a time slot, the current viewer population and their profile information is retrieved from the viewing profile generator 220 and the browsing profile generator 230 by the ad selector and scheduler 240. This information, when matched with the advertisers' one or more target viewer profiles, generates a unique bid for each possible pair of viewer and ad.

A digital TV ad distribution system usually comes with some constraints, e.g., how many different ads can be shown to the population at a certain ad time slot, how much bandwidth can be used for serving ads, etc. For example, FIG. 2 illustrates system constraints of a bandwidth of 1.5 Megabits per second (Mbps), a splicing capacity of 2, and a grouping have two viewer groups 34562 and 12. Only viewer group 34562 is shown in FIG. 2. The ad selector and scheduler 240 receives this information, and determines the bid for each pairing of viewer and ad. The ad selector and scheduler 240 then selects the best or better matching ads for the viewer population that maximizes or improves the service provider's revenue, as described in further detail below.

The ad selector and scheduler 240 includes hardware and/or software capable of receiving, collecting, processing and forwarding information. For example, the ad selector and scheduler 240 may include a processor (not shown) to receive, process and forward information received from the ad bidders 210, the viewing profile generator 220, the browsing profile generator 230 and system constraints. The ad selector and scheduler 240 may also include a memory (not shown) that may store the received information and/or programs such as the ad selection algorithm for use with the processor.

Advertisement time slots are indexed by t=1,2, . . . , T. An ad can be shown to the viewer only if the viewer j is watching TV in the time slot t. Such a viewer j is one of the viewers of a set of viewers S(t) that are watching TV at the time slot t. It is assumed that at any time slot t, at most K distinct ads from a set of distinct ads Sₖ can be shown to the set of viewers S(t). As noted above, the number of distinct ads K that can be shown to the viewers is determined by the system constraints. For example, this may be accomplished by having K dedicated ad channels where each ad channel would show a different ad and any viewer can be switched to any ad channel for the duration of the advertisement. Alternatively, there may be in-network splicing capability for K streams and K different ads may be shown to different viewers by splicing the ads to their respective streams.

Therefore, the ad selector and scheduler 240 performs two steps at each of the time slots t: 1) selecting the set of distinct ads Sₖ that are to be shown at the current time slot t; and 2) scheduling each of the viewers j from the set of viewers S(t) to one of the ads in the set Sₖ.

The ad selector and scheduler 240 will be described in more detail below in conjunction with the flowchart of FIG. 5. FIG. 5 illustrates a method for targeting an advertisement according to an example embodiment.

In FIG. 5, at step S100, the ad selector and scheduler 240 determines the set of viewers S(t)j that are available at the current time t.

At step S102, the ad selector and scheduler 240 determines the plurality of ads i that are available at the current time slot t. This may simply be the number of ads received for showing by the service provider. Steps S100 and S102 may be interchanged and/or combined.

At step S104, the ad selector and scheduler 240 forms an array of bids bₜ(i,j). Assuming that the advertisers have bid on target viewer profiles and/or ad slots, the bid bₜ(i,j) by the advertiser (or the expected revenue for the service provider) will be the highest bid for ad i associated with target profile and/or ad slot information corresponding to actual profile and/or ad slot information for viewer j. An example of an array of bids bₜ(i,j) is shown in FIG. 6A.

FIG. 6A illustrates a bid array according to an example embodiment. In FIG. 6A the columns represent the ads i from the set of ads S(t) and the rows represent the viewers j from the set of viewers S(t) in the bid array 600. Each of the values at a corresponding intersection of the viewer j and the ad i in the bid array 600 correspond to the bid WO. For example, the bid for viewer 3 and ad 2 at the current time slot t is bt(3,2). While only 4 viewers and 5 ads are shown in FIG. 6A, example embodiments may include greater or fewer numbers of viewers and/or ads.

While discussed above in detail, derivation of an advertiser's bid bₜ(i,j) on a particular viewer j for the ad i will be reviewed below. If an advertiser bids on an ad slot, the set of viewers S(t) that are watching the channel can be readily determined in a digital TV distribution system. If the advertiser bids on a target viewer profile, the ad selector and scheduler 240 can determine from the actual viewer profile, the set of viewers S(t) that match the target viewer profile in which the advertiser is interested. If an advertiser bids on both the target viewer profile and an ad slot of the TV program, then an intersection of the above two sets gives the set of viewers S(t) in which the advertiser is interested. Moreover, as described in FIG. 4, each of the ads i may have multiple target viewer profiles, where each of the target viewer profiles has a separate bid bₜ(i,j). Therefore, the bid bₜ(i,j) having the highest value may be selected for a viewer j that matches multiple target profiles of the advertiser for ad i. For example, in FIG. 4, if the viewer's actual viewer profile matched the target web browsing profile for both “car” and “Cadillac” but did not match the target TV viewing profile for “sports,” then the viewer's actual profile would match both of the bids “2” and “3.” However, the ad selector and scheduler 240 would select the higher bid value (e.g., 3) for the bid bₜ(i,j) in the bid array 600 in FIG. 6A. Thus, the ad selector and scheduler 240 is configured to determine the determined bid of a viewer j and ad i pair as the highest bid bₜ(j) associated with target profile and/or ad slot information corresponding to the actual profile and/or ad/slot information of the viewer j.

Returning to FIG. 5, in step S106, the ad selector and scheduler 240 forms a weighted array from the bid array 600. For example, the ad selector and scheduler 240 adjusts each of the bids bₜ(j) in the bid array 600 based on a throttling parameter δ(i,t) to form the weight w(i,j), as shown by the below equation.

j ∈ S(t)

i ∈ Sₖ

w(i,j)=bₜ(i,j) (1−δ(t,t))

The throttling parameter δ(i,t) improves or optimizes spending of the advertiser's budget B(i), where the budget B(i) indicates a maximum amount the advertiser will pay to have the ad i displayed over a time duration, such as T. For example, incorporation of the throttling parameter δ(i,t) into determining the weight may act to ration the advertisers budget B(i) so that the advertiser is able to display an ad i over a longer period of time. Otherwise, without the throttling parameter δ(i,t), the advertiser's ad may be shown over a much shorter period of time. As will be shown below, the throttling parameter δ(i,t) for an ad i increases as the budget B(i) for the ad i decreases and the weight w(i,j) therefore decreases as the throttling parameter δ(i,t) increases.

Thus, the ad selector and scheduler 240 is configured to determine which of the plurality of ads i is received by which of the plurality of viewers j based the determined weights such that an expected revenue from showing an ad as indicated by the bid bₜ(i,j) is discounted based on an amount of the budget B(i) used. This will be described in more detail below.

The ad selector and scheduler 240 implements a primal-dual algorithm with the throttling parameter δ(i) and a monitoring parameter π(t) denoting the dual variables. In order to track the changes in the value of the dual variable δ(i), an explicit index is added for time to derive the throttling parameter δ(i,t), which is used to denote the value of the dual variable δ(i) at the end of time slot t. The dual variable TO may be used for analysis of the ad selection algorithm used by the ad selector and scheduler 240, but the value of π(t) is not used for actual ad selection by the ad selector and scheduler 240. The dual variable π(t) will be explained in further detail below.

The dual variables δ(i) and π(t) are initialized to zero for all the ads i and the dual variables δ(i) and π(t) are updated in each time slot t. A revenue T(i,t) generated from the ad i in the time slot t is also initialized to zero for all the ads i. The revenue T(i,t) is based on the bid value bₜ(i,j) of an ad i selected by the ad selector and scheduler 240 and shown to viewer j, as shown by the equation below.

T(i,t)←T(i,t)+bₜ(i,j)

It is noted that T(i,t) is zero when the ad i is not scheduled at time t. Also

$${\sum }_{m = 1}^{t} T ( i , m )$$

represents the total amount of revenue generated from ad i up to time slot t. The ad selector and scheduler 240 ensures that

$${\sum }_{t} T ( i , t ) \leq {B}_{i}$$

for all ads i.

The throttling parameter δ(i,t) is based on a value of the throttling parameter at a previous time slot δ(i,t-1) and a portion of the budget used B(i) to create the revenue T(i,t) along with additional control parameters a, c, and R, as shown by the following equations.

$$δ ( i , t ) ← 0 , ∀ i$$

$$T ( i , t ) ← 0 , ∀ i$$

$$δ ( i , t ) ← δ ( i , t - 1 ) [ 1 + \frac{α T ( i , t )}{B ( i )} ] + \frac{α T ( i , t )}{( {c}^{α} - 1 ) B ( i )}$$

$$α = 1 - {( 1 - \frac{1}{K} )}^{K}$$

$$c = {( 1 + R )}^{\frac{1}{R}}$$

$$R = {max}_{i} {max}_{t} ( \frac{T ( i , t )}{B ( i )} )$$

FIG. 6B illustrates an example of a weighted array according to an example embodiment. The values shown at the intersection of the viewers j and ads i represent sample values of the weights w(i,j) for each pair of the viewer j and the ad i. As explained above, the weights w(i,j) are based on the bid bₜ(i,j) and the throttling parameter δ(i,t) for the available ads i and available viewers j at the current time slot t.

Returning to FIG. 5, at step S106, the ad selector and scheduler 240 selects a first ad i from the plurality of ads based on the ad i that has a highest total weight for the plurality of viewers i. FIG. 6C show an example of selecting the first ad i.

FIG. 6C illustrates an example of selecting a first ad from the weighted array of FIG. 6B. In FIG. 6C, the total weight for each ad i is determined based on summing the weight for each of the viewers j for the ad i. As shown in FIG. 6C, the first ad 1 has a total weight of 14, a second ad 2 has a total weight of 7, a third ad 3 has a total weight of 2, a fourth ad 4 has a total weight of 4, and a fifth ad 5 has a total weight of 3. Therefore, because the first ad 1 has a highest total weight from among the all the ads 1-5, the first ad 1 is selected by the ad selector and scheduler 240. The throttling parameter δ(i,t) is also updated for the selected ad 1.

Returning to FIG. 5, at step S110, the ad selector and scheduler 240 sets an ad number k to 1 to indicate that one ad has been selected.

At step S112, the ad selector and scheduler 240 determines whether the ad number k is equal to a system constraint K. This is because, as described above, the number of ads k that can be shown at any given time slot t is limited to a maximum of K ads.

If the ad selector and scheduler 240 determines that the ad number k is not equal to the system constraint K, then the ad selector and scheduler 240 will select another ad at step S114. Otherwise, the ad selector and scheduler 240 will proceed to step S118, as described below. In this case, we will assume that the system constraint K=3. Therefore, the ad selector and scheduler 240 will proceed to step S114 to select another ad.

At step S114, the ad selector and scheduler 240 adjusts the weighted array and then selects another ad. FIG. 6D shows an example of adjusting the weighted array and selecting a subsequent ad.

FIG. 6D illustrates an example of adjusting the weighted array of FIG. 6C and selecting a second ad from the adjusted weighted array of FIG. 6C. In FIG. 6D, the ad selector and scheduler 240 adjusts each of the weights for each pair of viewer j and ad i from the plurality of viewers 1-4 and unselected ads 2-5 of the plurality of ads based on the weights for the plurality of viewers j of the selected ad by replacing the weight for a viewer j of the unselected ad with a minimal value (e.g., 0) if the weight of the viewer j of the unselected ad is less than or equal to (or alternatively, only less than) the weight of the viewer j of the selected ad. Also, in the event that the weight of the viewer j of the unselected ad is equal to the weight of the viewer j of the selected ad, whether and the weight of the viewer j of the unselected ad replaced may be determined arbitrarily.

For example, referring to FIGS. 6C and 6D, the respective weights of 1, 0, 0, 1 of the second through fifth unselected ads 2-5 for the first viewer 1 are less than the weight 10 for the first selected ad 1 for the first viewer 1. Therefore, the respective weights of 1, 0, 0, 1 of the second through fifth unselected ads 2-5 for the first viewer 1 are minimized, for example, to 0. In this case, as the respective weights 0, 0 of the third through fourth unselected ads 3-4 for the first viewer 1 are already 0, only the weights of 1 of the second and fifth unselected ads 2 and 5 for the first viewer 1 are minimized to 0. The above minimizing of the weights is similarly carried for the remaining second through fourth viewers 2-4. For example, for the second viewer 2, the weight of 1 of the second unselected ad 2 is less than the weight of 2 of the first selected ad 1, and therefore the weight of the second unselected ad 2 is minimized to 0. On the other hand, the weight of 3 of the fourth unselected ad 4 is greater than the weight of 2 of the first selected ad 1, and therefore the weight of 3 of the fourth unselected ad 4 remains unchanged. Upon completion of the adjusting of weights for all of the users 1-4, the adjusted weighted array 630 only has the following nonzero values: w(4,2)=3, w(2,3)=5, w(3,4)=2 and w(4,4)=1.

Next, similar to FIG. 6C, the total weight for each of the unselected ads 2-5 in the adjusted weight array 630 is determined by the ad selector and scheduler 240. As shown in FIG. 6D, the second unselected ad 2 has a total weight of 5, which is greater than the respective total weights of 2, 4, 0 of the third through fifth unselected ads 3-5. Therefore, the ad selector and scheduler 240 then selects the second ad 2. The throttling parameter δ(i,t) is also updated for the selected ad 2.

Returning to FIG. 5, at step S116, the ad selector and scheduler 240 increments the ad number k to indicate that another ad has been selected from the adjusted weighted array 630.

Next, the ad selector and scheduler 240 returns to step S112 to determine whether the ad number k is equal to the system constraint K. As the ad number k is currently 2 and the system constraints variable K is 3, the ad selector and scheduler 240 will return to step S114.

As explained above, at step S114, the ad selector and scheduler 240 adjusts the weighted array based on the selected ads and then selects another ad. FIG. 6E shows an example of adjusting the weighted array and selecting a successive ad.

FIG. 6E illustrates an example of adjusting the weighted array of FIG. 6D and selecting a third ad from the adjusted weighted array of FIG. 6D. In FIG. 6E, the third ad is selected in a similar fashion to the second selected ad 2, as described above with respect to FIG. 6D. However, in FIG. 6E, two ads 1, 2 have already been selected whereas in FIG. 6D only one ad 1 had already been selected. Therefore, where more than one ad has been selected, the ad selector and scheduler 240 will minimize those weights w(i,j) of the remaining unselected ads in the weighted adjusted array that are less than or equal to (or alternatively, only less than) the weight of at least one of the selected ads for the corresponding viewer j.

For example referring to FIG. 6E, the weight w(4,2) of the ad-viewer pair for the fourth ad 4 and the second viewer 2 is 3, which is still greater than the weights of the selected ads 1 and 2 for the second viewer. Therefore, the weight w(4,2) of the ad-viewer pair for the fourth ad 4 and the second viewer 2 remains unchanged. If, for example, the weight w(4,2) of the ad-viewer pair for the fourth ad 4 and the second viewer 2 had been 1, it would have been at least less than the weight of the selected ad 1 for the second viewer, and therefore set to 0.

After the above minimizing of the weights is carried for the unselected third through fifth ads 3-5, the total weight for each of the unselected ads 3-5 is determined by the ad selector and scheduler 240. As shown in FIG. 6E, the fourth unselected ad 4 has a total weight of 4, which is greater than the respective total weights of 2 and 0 of the third and fifth unselected ads 3, 5. Therefore, the ad selector and scheduler 240 then selects the fourth ad 4. The throttling parameter δ(i,t) is also updated for the selected ad. The selected ads, such as the ads 1, 2 and 4, form the set of distinct ads Sₖ.

Returning to FIG. 5, at step S116, the ad selector and scheduler 240 increments the ad number k to indicate that another ad has been selected from the adjusted weighted array 630.

Next, the ad selector and scheduler 240 again returns to step S112 to determine whether the ad number k is less than the system constraint K. As the ad number is now 3 and the system constraint K is 3, the ad selector and scheduler 240 proceeds to step S118.

At step S118, the ad selector and scheduler 240 is configured to schedule which of the selected ads is received by which of the plurality of viewers based on the weighted array 610 in FIG. 6B. FIG. 6F shows an example of scheduling the selected ads to the plurality of viewers.

FIG. 6F illustrates an example of scheduling the selected ads to the plurality of viewers according to an example embodiment. In FIG. 6F, weights for the selected ads (i.e., the first, second and fourth selected ads 1, 2 and 4) according to weighted array 610 of FIG. 6B are shown. The ad selector and scheduler 240 is configured to map each of the selected ads 1, 2 and 4 to a corresponding one of the viewers based on the determined scheduling weights for each pair of viewer and selected ad. Namely, the ad selector and scheduler 240 is configured to show each of the viewers j one of ads from the selected ads having a highest determined scheduling weight for the viewer j.

For example, as shown in FIG. 6F, for the first viewer 1, the first selected ad 1 has a highest weight of 10 from the first, second and fourth selected ads 1, 2 and 4, where the second and fourth selected ads 2, 4 have respective weights of 1 and 0 for the first viewer 1. Therefore, the ad selector and scheduler 240 schedules the first selected ad 1 to the first viewer 1.

For the second viewer 2, the fourth selected ad 4 has a highest weight of 3 from the first, second and fourth selected ads 1, 2 and 4, where the first and second selected ads 1, 2 have respective weights of 2 and 1 for the second viewer 2. Therefore, the ad selector and scheduler 240 schedules the fourth selected ad 4 to the second viewer 2.

For the third viewer 3, the second selected ad 2 has a highest weight of 5 from the first, second and fourth selected ads 1, 2 and 4, where the first and fourth selected ads 1, 4 have respective weights of 1 and 0 for the third viewer 3. Therefore, the ad selector and scheduler 240 schedules the second selected ad 2 to the third viewer 3.

For the fourth viewer 4, the fourth selected ad 4 has a highest weight of 1 from the first, second and fourth selected ads 1, 2 and 4, where the first and second selected ads 1, 2 have respective weights of 0 and 0 for the fourth viewer 4. Therefore, the ad selector and scheduler 240 schedules the fourth selected ad 4 to the fourth viewer 4.

As shown in FIGS. 6B and 6F, while the third ad 3 has the highest weight of 2 for the fourth viewer 4, the ad selector and scheduler 240 schedules the fourth ad 4 to the fourth viewer. Thus, it will be appreciated that the ad selector and scheduler 240 is configured to schedule which of the ads is received by which of a plurality of viewers such that the ad shown to a viewer is not necessarily the ad that will generate the highest revenue if shown to the viewer. Moreover, it should be appreciated that the ad selector and scheduler 240 is configured to schedule which of the plurality of ads is received by which of a plurality of viewers based on the actual profile information of the plurality of viewers and the bidding information such that an ad scheduled for one of the plurality of viewers is influenced by a correspondence of the scheduled ad to others of the plurality of viewers.

Upon completion of mapping all the users to one of the selected ads, the ad selector and scheduler 240 may update the throttling parameter δ(i,t) for the next time slot, where the method of FIG. 5 is carried out for each of the time slots t.

Further, while the method of FIG. 5 is illustrated with respect to selecting a single ad at a time for the selected ads, example embodiments may also be carried out for simultaneously selecting a plurality of ads. For example, at step S114 in FIG. 5, two or more of the ads may be selected at a time. In this approach, the each pair of ads is considered as a single ad with the scheduling weight for each user being the highest scheduling weight between the two ads. Adjustments, etc. of the scheduling weights are similarly handled.

According to an example embodiment, the ad selector and scheduler 240 schedules which of the plurality of ads is received by which of the plurality of viewers based on the bids, the budgets and the system constraints.

At the end of each time period, a dual feasible solution is maintained. The value of the dual variable π(t) is computed at time slot t and is not updated later. As explained above, the dual variable π(t) is only used for analysis of the ad selection algorithm and is not used for selecting or scheduling of the ads L The dual variable g(t) is based on at least the revenue T(i,t) and a value of the throttling parameter from the previous time slot δ(i,t-1), as shown by the below equation.

$$π ( t ) ← a {\sum }_{i} T ( i , t ) [ I - δ ( i , t - 1 ) ]$$

Returning to FIG. 2, upon mapping the selected ads to the viewers, the ad selector and scheduler 240 forwards a message to the ad displayer 250 indicating at least which of the selected ads is to be received by which of the plurality of viewers. The ad selector and scheduler 240 may also forward the time the ad is to be displayed and the revenue generated from the ad. The ad displayer 250 is configured to display the ad to the device of the viewer, such as the TV or the computer via the network. The ad displayer 250 may include hardware and/or software capable of receiving, collecting, processing and forwarding the ad and related information from the ad selector and scheduler 240 to the viewer. For example, the ad displayer 250 may include a processor (not shown) to receive, process and forward the ad and related information and a memory (not shown) that may store the ad and related information and/or programs for use with the processor. The advertisers 1-n may send the bidding entry to the ad bidder 210 via the network.

While the system of FIG. 2 shows the ad selector and scheduler 240 being applied only to displaying ads for a digital TV service, the system of FIG. 2 may also be applied to various other services as well, such as Internet and mobile services.

All of the above described functions may be readily carried out by special or general purpose digital information processing devices acting under appropriate instructions embodied, e.g., in software, firmware, or hardware programming.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

Example embodiments being thus described, it will be obvious that the same may be varied in many ways. Such variations are not to be regarded as a departure from the invention, and all such modifications are intended to be included within the scope of the invention.

I/We claim:

1. A system for scheduling advertisements, comprising:
at least one ad bidder configured to receive bidding information for a plurality of ads from one or more advertisers, the bidding information for each ad including at least one target profile information and a bid associated with the target profile information, the bid indicating expected revenue for showing the ad to a viewer having actual profile information corresponding to the target profile information associated with the bid; and
an ad scheduler configured to schedule which of the plurality of ads is received by which of a plurality of viewers based on the actual profile information of the plurality of viewers and the bidding information such that an ad scheduled for one of the plurality of viewers is influenced by a correspondence of the scheduled ad to others of the plurality of viewers.

2. The system of claim 1, wherein the ad scheduler is configured to determine a bid for each pair of viewer and ad from the plurality of viewers and the plurality of ads based on the target profile information and the actual profile information, and is configured to schedule which of the ads is received by which of a plurality of viewers based the determined bids.

3. The system of claim 2, wherein the target profile information includes at least one of target television profile information and target web-browsing information, and the actual profile information includes at least one of actual television profile information and actual web-browsing information.

4. The system of claim 2, wherein the at least ad includes multiple target profile information and a bid associated with each target profile information, and the scheduler is configured to determine the determined bid of a viewer and ad pair as the highest bid associated with target profile information corresponding to the actual profile information of the viewer.

5. The system of claim 2, wherein,
the bidding information for each ad includes a budget indicating an amount the advertiser is willing to pay to have the ad shown over a period of time; and
the ad scheduler is configured to schedule which of the plurality of ads is received by which of the plurality of viewers based the determined bids and the budgets.

6. The system of claim 5, wherein the ad scheduler is configured to schedule which of the plurality of ads is received by which of the plurality of viewers based the determined bids and the budgets such that an expected revenue from showing an ad as indicated by the bid is discounted based on an amount of the budget used.

7. The system of claim 6, wherein the ad scheduler is configured to schedule which of the plurality of ads is received by which of the plurality of viewers based on the determined bids, the budgets and a constraint, and the constraint is a number of ads that can be shown at the current time slot.

8. The system of claim 5, wherein,
the ad scheduler is configured to determine a throttling parameter for each ad of the plurality of ads based on the budget associated with the ad;
the ad scheduler is configured to determine a scheduling weight for each pair of viewer and ad from the plurality of viewers and the plurality of ads based on the determined bid for the pair and the throttling parameter for the ad in the pair; and
the ad scheduler is configured to schedule which of the plurality of ads is received by which of the plurality of viewers based the determined scheduling weights.

9. The system of claim 8, wherein the ad scheduler is configured to,
determine an ad from the plurality of ads having a highest total determined scheduling weight for the plurality of viewers as a first selected ad;
adjust each of the determined scheduling weights for each pair of viewer and ad from the plurality of viewers and unselected ads of the plurality of ads based on the determined scheduling weights for the plurality of viewers of the selected ad; and
determine an ad from the unselected ads having a highest total adjusted scheduling weight for the plurality viewers as a next selected ad.

10. The system of claim 9, wherein the ad scheduler is configured to repeat the adjusting and the determining an ad from the unselected ads until a number of ads is selected.

11. The system of claim 10, wherein the number of ads selected is a maximum number of ads that can be shown in the current time slot.

12. The system of claim 9, wherein the ad scheduler is configured to adjust each of the determined scheduling weights for each pair of viewer and ad from the plurality of viewers and unselected ads of the plurality of ads based on the determined scheduling weights for the plurality of viewers of the selected ad by replacing the determined scheduling weight for a viewer of the unselected ad with a minimal value if the determined scheduling weight of the viewer of the unselected ad is less than or equal to the determined scheduling weight of the viewer of the selected ad.

13. The system of claim 10, wherein the ad scheduler is configured to show each viewer an ad from the selected ads having a highest determined scheduling weight for the viewer.

14. The system of claim 13, wherein
the throttling parameter for an ad increases as the budget for the ad decreases; and
the determined scheduling weight decreases as the throttling parameter increases.

15. The system of claim 14, wherein the ad scheduler is further configured to determine the throttling parameter for each of the plurality of ads based a value of a previous throttle parameter and a portion of the budget used.

16. The system of claim 9, wherein the ad scheduler is configured to map each of the selected ads to a corresponding one of the viewers based on the determined scheduling weights for each pair of viewer and selected ad.

17. The system of claim 2, wherein the ad scheduler is configured to schedule which of the ads is received by which of a plurality of viewers based on the determined bids and a constraint, and the constraint is a number of ads that can be shown at the current time slot.

18. The system of claim 1, wherein,
the bidding information for at least one ad associates a bid with channel and ad slot information, the bid indicating revenue expected for showing the ad during a particular ad slot of the channel; and
the ad scheduler is additionally configured to schedule which of the plurality of ads is received by which of the plurality of viewers based on the channel and ad slot information.

19. The system of claim 1, further comprising:
a viewing profile generator configured to mine the actual television viewing profile information of each viewer based on information about a channel watched by the viewer and a time period the channel is watched by the viewer; and
a browsing profile generator configured to mine the actual web browsing profile information of each viewer based on information about at least one of web pages visited and internet searches by the viewer.

20. The system of claim 1, wherein the ad scheduler is configured to schedule which of the ads is received by which of a plurality of viewers such that the ad shown to a viewer is not necessarily the ad that will generate the highest revenue if shown to the viewer.
